(19) United States
(12) Patent Application Publication
(10) Pub. No.: US 2018/0075138 A1
(43) Pub. Date: Mar. 15, 2018

(54) ELECTRONIC DOCUMENT MANAGEMENT USING CLASSIFICATION TAXONOMY

(71) Applicant: FileFacets Corp., Kanata (CA)

(72) Inventors: Christopher John Perram, Kanata (CA); Kirill Vladimir Kashigin, Toronto (CA)

(21) Appl. No.: 15/701,861

(22) Filed: Sep. 12, 2017

Related U.S. Application Data
(60) Provisional application No. 62/394,262, filed on Sep. 14, 2016.
(60) Provisional application No. 62/512,411, filed on May 30, 2017.

(51) Int. Cl. G06F 17/30; G06F 21/62

(52) U.S. Cl. CPC G06F 17/30707; G06F 21/6245; G06F 17/30011

(57) ABSTRACT

A method and system for electronic document management comprising identifying a legacy content repository, capturing source data for the set of electronic documents from the legacy content repository, extracting textual content from each electronic document in the set of electronic documents to identify classification criteria, classifying each electronic document in the set of electronic documents in a classification taxonomy, and attributing updated metadata for each electronic document in the set of electronic documents according to the classification structure.

### RELATED APPLICATIONS

The present invention is related to and claims priority to U.S. Provisional Application No. 62/394,262, filed Sep. 14, 2016 and also claims priority to U.S. Provisional Application No. 62/512,411, filed May 30, 2017.

### FIELD OF THE INVENTION

The present invention pertains to a method and system for electronic document management using classification taxonomy as well as to a method and system for identification, classification and management of information in a network of connected devices.

### BACKGROUND

Technological advances in the processing speed of computer hardware and networking and decreased costs of data storage have led to increased generation, use and storage of electronic information. Many organizations are either in the process of or have already migrated to being entirely paperless and rely on electronic documents and document management systems to store their critical data.

Companies, organizations and enterprises can generate vast numbers of electronic documents that require filing for archive and potential later retrieval. These electronic documents can include data and metadata for word processing, spread sheets, presentation software, mail applications, contact applications, networks, instant messaging applications, as well as personally identifiable information, and can further include a wealth of information about the user generator of the document itself as well as a user's contact lists and/or interaction with contacts. Without proper filing and classification, over time the number of electronic documents can amass into an overwhelming amount of electronic data to store and can be unmanageable for searching and retrieval, as well as pose a potential liability.

U.S. Pat. 8,676,806 to Simard describes a method for collecting and organizing electronic documents based on static and dynamically generated metadata associated with the documents.

Thus, there remains a need for a method and system for electronic document management that can be applied to large groups of documents to create an organized classification structure.

Further, technological advances in the processing speed of computer hardware and networking as well as decreased data storage costs have led to increased creation, use, and storage of electronic information. Many organizations are either in the process of, or have already migrated, to being entirely paperless and instead rely on electronic documents and document management systems to store most if not all their critical data and information.

As a result, companies, organizations and enterprises now generate vast numbers of electronic documents that require filing in repositories for archive and potential later retrieval. These documents can include information, data and metadata for word processing, spread sheets, presentation software, mail applications, contact applications, networks, instant messaging applications, as well as personally identifiable information, and can further include a wealth of information about the user generator of the document itself as well as a user's contact lists and/or interaction with contacts. Over time, an overwhelming amount of electronic data and information becomes stored, which because of size can become unmanageable for searching and retrieval.

A concern for all companies is the management of personally identifiable information (PII). Personally identifiable information (PII) is any data that could potentially identify a specific individual or organization, contact or locate a single person, or identify an individual in context. Any information that can be used to distinguish one person or entity from another or to de-anonymize anonymous data can be considered as PII. Examples of PII include but are not limited to name, home address, email address, national identification number, passport number, IP address, Social Insurance Number, bank account number, vehicle registration plate number, driver's license number, face image, fingerprint, handwriting sample, credit card number, digital identity, date of birth, birthplace, genetic information, telephone number, electronic login name, screen name, nickname, and online handle.

Many federal and state laws and regulations have been passed to protect PII. Certain standard types of records contain this information, as well as ad hoc documents. Because of the large amount of stored information, companies often struggle to locate these records and redact the PII in order to meet the legal and regulatory requirements.

Recently EU has promulgated the General Data Protection Regulation (GDPR) (Regulation (EU) 2016/679) by which the European Parliament, the Council of the European Union and the European Commission intend to strengthen and unify data protection for all individuals within the European Union (EU). The EU regulation also addresses the export of personal data outside the EU. The primary objectives of the GDPR are to give citizens and residents back control of their personal data and to simplify the regulatory environment for international business by unifying the regulation within the EU. The GDPR provides that individual users will have the right to request erasure of all personal data, which implies that companies and organizations will need to be able to identify and classify all data and information across all devices and all stored data within their networks.

There therefore also remains a need for a centralized method and system to identify, classify, and manage PII across all devices and data in a connected organizational network.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and system for electronic document management using classification taxonomy.

In an aspect there is provided a method for electronic document management comprising: identifying a legacy content repository comprising a set of electronic documents stored in a computer readable memory in the content repository; electronically capturing source data for the set of electronic documents from the legacy content repository; electronically extracting textual content from each electronic document in the set of electronic documents to identify classification criteria; electronically classifying each electronic document in the set of electronic documents in a classification taxonomy, wherein the classification taxonomy comprises a classification structure and the classification criteria; and electronically attributing updated metadata for each electronic document in the set of electronic documents according to the classification structure.

In an embodiment, the method further comprises migrating the set of electronic documents and captured source data from the legacy content repository into a target content repository using the classification structure.

In another embodiment, the method further comprises storing a stub that points back to each electronic document in the set of electronic documents in the classification structure.

In another embodiment, the textual content comprises at least one of a regular expression, personally identifiable information and metadata.

In another embodiment, the legacy content repository comprises more than one electronic storage location.

In another embodiment, extracting textual content comprises searching for matching electronic documents in the set of electronic documents against a template comprising anchor points.

In another embodiment, the method further comprises purging the set of electronic documents of documents that are redundant, out-of-date, trivial, or a combination thereof.

In another embodiment, the updated metadata comprises a retention schedule.

In another embodiment, filters are applied to capture a subset of electronic documents from the legacy content repository.

In another embodiment, the method further comprises identifying, in the set of electronic documents, electronic document versions, duplicate electronic documents, and electronic documents with business value.

In another embodiment, the method further comprises performing quality assurance of the correctness of the classification structure and updated metadata.

In another embodiment, the method further comprises selecting a subset of documents from the set of electronic documents, classifying the subset of electronic documents, and reviewing the accuracy of the subset of classified electronic documents. In another embodiment, reviewing the accuracy of the subset of classified electronic documents further comprises enabling a user to accept or reject a classification.

In another embodiment, the classification taxonomy is dynamically updated.

In another aspect there is provided an electronic document management system comprising: one or more processors; and a memory accessible to the one or more processors, the memory storing instructions executable by the one or more processors to: identify a legacy content repository comprising a set of electronic documents; capture source data for the set of electronic documents from the legacy content repository; extract textual content from each electronic document in the set of electronic documents to identify classification criteria; classify each electronic document in the set of electronic documents into a classification taxonomy, wherein the classification taxonomy comprises a classification structure and the classification criteria; and attribute updated metadata for each electronic document in the set of electronic documents according to the classification structure.

In an embodiment of the system, the one or more processors is further configured to migrate the set of electronic documents and captured data from the legacy content repository into a target content repository using the classification structure.

In another embodiment, the one or more processors is further configured to store a stub that points back to each electronic document in the set of electronic documents in the classification structure.

In another embodiment, the processor comprises storage, versioning, metadata, security, indexing, and retrieval capabilities.

In another embodiment, the system further comprises an associated or embedded communications system.

In another embodiment, the system further comprises a cloud memory structure for storing the classification taxonomy.

In another embodiment, the one or more processors are in more than one computing device in communication over a telecommunications network.

In another aspect there is provided a method of classifying a set of documents, the method comprising: electronically creating a document classification structure having document types; electronically assigning a document training set to be classified; assigning each document from the document training set to the classification structure; electronically extracting textual content from each classified document to assign classification criteria to each document type; electronically creating a classification taxonomy comprising the document classification structure and criteria; electronically applying the classification taxonomy to a set of documents to be classified.

In an embodiment of the method, the classification taxonomy is specific to an industry or business function.

In another embodiment, the document training set is not a subset of the set of documents to be classified.

In another embodiment, the classification taxonomy is available in a cloud based computing system for auto-classification of documents.

In another embodiment, the classification taxonomy evolves during use based on the classification criteria.

In another embodiment, the classification taxonomy evolves during use based on the classification structure.

In another embodiment, the document training set comprises documents from more than one entity.

In another embodiment, the classification criteria is hidden from the user.

In another embodiment, the set of documents can be classified without exposing the contents of the set of documents to the user.

Another object of the present invention is to provide a method and system for information identification, classification and analysis across all devices and data in a connected network.

In another embodiment, a method for information identification, classification and analysis is provided comprising: identifying all devices within a network; connecting to each device from a central location; identifying content on each device; classifying the content; analyzing the content; and/or obscuring, encrypting, or deleting the content.

In another embodiment, the content comprises textual content.

In another embodiment, the content comprises user personally identifiable information (PII).

In another embodiment, where if the content does not comprise personal information subject to the General Data Protection Regulation (GDPR) (Regulation (EU) 2016/679), the method further comprises migrating the content to a repository.

In another embodiment, identifying content comprises matching content on devices in a network against content stored elsewhere.

In another embodiment, the method further comprises deleting content on the devices if the content matches a particular classification.

In another embodiment, the method comprises identifying, in the content, electronic document versions, duplicate electronic documents, and electronic documents with business value.

In another embodiment a method for information identification and management in a network of devices is provided comprising: identifying at least some devices in the network; accessing information on the at least some of the devices; classifying the information to identify if the information is personally identifiable information; and deleting the information from the devices if the information is personally identifiable information.

In another embodiment, the at least some of the devices comprises all the devices in the network.

In another embodiment, the step of deleting is performed from a single location.

In another embodiment, the single location is located outside the network.

In another embodiment, the step of deleting is performed from a single location by an authorized user.

In another embodiment, a method for information identification and management in a network of devices is provided comprising: identifying at least some devices in the network; accessing information on the at least some of the devices; determining if the information falls within a certain class of information; and deleting the information from the devices if the information falls within the class of information.

In another embodiment, the at least some of the devices comprises all the devices in the network.

In another embodiment, the step of deleting is performed from a single location.

In another embodiment, the single location is located outside the network.

In another embodiment, the step of determining includes a statistical analysis that determines if the information is classified properly.

In another embodiment, the information comprises personally identifiable information.

In another embodiment, the information is identified by comparison against textual information provided at the single location.

In another embodiment, a method for information identification and management in a network of devices is provided comprising: identifying at least some devices in the network; accessing information on the at least some of the devices; and obscuring or encrypting the information if the information is personally identifiable information.

In another embodiment, at least some of the devices comprise all the devices in the network.

In another embodiment, a system for information and identification and management, comprises: a network comprised of devices connected to the network; and a central location that does not comprise the devices, where each of the devices comprises a memory and a processor, and where a set of instructions embodied in the memory enables the memory to be accessed by a user at the central location.

In another embodiment, the set of instructions enable the user at the central location to access and identify information stored in the memory.

In another embodiment, the information comprises personally identifiable information.

In another embodiment, the system comprises a classifier configured to classify the information.

In another embodiment, the system further comprises an analyzer configured to analyze the classified information to verify the classification of the information can be trusted.

In another embodiment, the system is configured to enable the user to delete all the personally identifiable information from all the devices in the network.

The present invention is not to be limited by the embodiments above as other aspects and advantages will be evident upon a reading the description below.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a flow chart illustrating an overview of an electronic document management system according to an example embodiment;

FIG. 2 is a flow chart illustrating a document capture and metadata capture process according to an example embodiment;

FIGS. 3A and 3B comprise a flow chart illustrating a document clustering process to create a working classification structure according to an example embodiment;

FIG. 4 is a flow chart illustrating a document classification by confidence process according to an example embodiment;

FIGS. 5A and 5B comprise a flow chart illustrating a document migration process according to an example embodiment;

FIGS. 6A and 6B comprise a flow chart illustrating a metadata attribution process according to an example embodiment;

FIG. 7 is a depiction of a system overview of the document in accordance with one embodiment;

FIG. 8 represents a flow diagram showing migration of information from a legacy content repository to a target content repository;

FIG. 9 represents a system that implements migration of information in FIG. 8;

FIG. 10 represents a system of the present invention that includes both repositories and devices;

FIG. 11 represents a memory on a representative device; and

FIG. 12 a flow diagram for use of the present invention.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The term “user”, as used herein, includes but is not limited to one or more persons, software, computers or other devices, or combinations of these.

The term “software” as used herein, includes but is not limited to one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a cloud-based program, a servelet, an applet, instructions stored in a memory, or part of an operating system or other types of executable instructions.

The terms “utility” and “application” as used herein, include but are not limited to one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a cloud-based program, a servlet, an applet, instructions stored in a memory, or part of an operating system or other types of executable instructions.

The term “metadata” as used herein refers to the informational content of various documents or files and may include, for example, the name of a document or file, file type, or the name and length of particular data items. Metadata can include but is not limited to a text string, a numerical value, a date or time, or other identifying information, and in some implementations some metadata may change as a predetermined function of time.

The term “high degree of accuracy” as used herein refers to the results of the classification and clustering system to accurately process documents. Preferably, the degree of accuracy of the present classification and clustering system is greater than 80%, greater than 90%, greater than 95%, greater than 97%, greater than 98%, or most preferably greater than 99%.

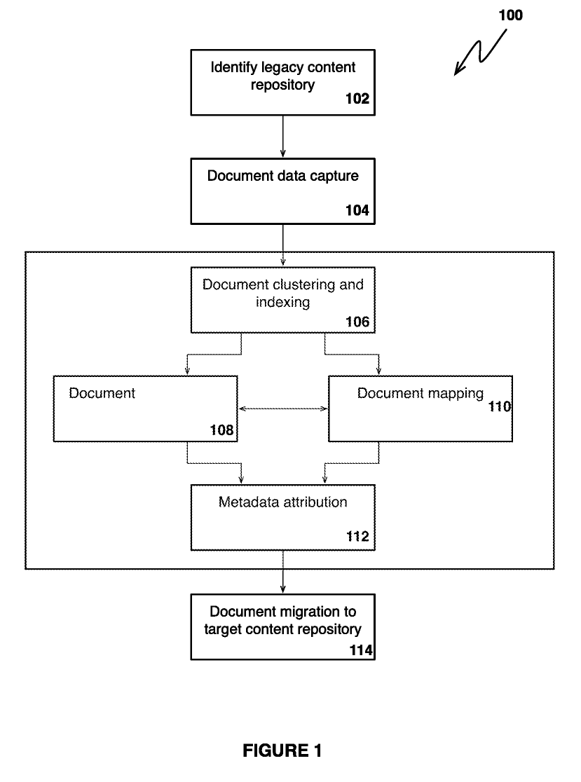

In one embodiment, an electronic document management method and system is provided for the organization of documents in a file content repository. Generally shown as an example in FIG. 1, the electronic document management system 100 identifies at least one legacy content repository 102 and performs a document data capture 104 on a set of documents in the legacy content repository to be organized. The document data capture 104 captures critical document identification, metadata and content information in a metadata extraction from textual content of each document stored in the legacy database, which is accessed for document processing. The document data obtained from the document data capture 104 is then processed in a document clustering and indexing step 106 which is performed by the utility to group documents within the set of documents into clusters based on similar criteria. This step facilitates the identification of document types to generate clusters used to group and present groups of documents with similar content to users. These data analysis steps provide updated document clusters based on the document data. Clustering of electronic documents can be used to identify documents by document type. Examples of file types of electronic documents to be managed can include but is not limited to documents that are attachments, emails, word processor documents, presentation documents, scanned documents, faxes, spreadsheets, drawings, figures, graphics, audio recordings, electronic mail (email), fax, handwritten notes, telephony recordings, portable document format (PDF), text messaging, invoice meeting minutes, memo, budgets, employee records and the like.

A document classification 109 procedure is then carried out, comprising document clustering and indexing 106, document quality assurance 108, document mapping 110, and metadata attribution 112. The output of document clustering and indexing 106 is a working cluster identifier for each of the electronic documents reviewed from the legacy content repository and a working classification structure. The working cluster identifier for each electronic document is then sent to a central location, such as a cloud system, so that the central location can present information to a user to execute a document classification and migration based on a working classification structure. Document quality assurance 108 and document mapping 110 are then performed on the set of documents by a combination of review by a user of the working classification structure from the document clustering and indexing step 106 performed by the utility and a manual classification by a user of each group of documents which have been classified and indexed. Individual documents or sets of documents can be reviewed by a user to validate classification, test classification, or improve the accuracy of classification. Once document classification and mapping is complete, a metadata attribution 112 is assigned to each of the group of documents with a cluster identifier for each of the electronic documents reviewed from the legacy content repository. The updated metadata attribution and cluster identifier is then sent to a central location, such as a cloud system, so that the central location can present information to a user to execute a document migration based on the accepted document mapping or mapped stub structure for document mapping. Finally, a document migration to a target content repository can be done according to the new classification structure.

In the present system and method, deep data identification and extraction with advanced quality assurance and results processing, capture, classification, metadata attribution, and migration of shared drive content into corporate taxonomies can be accomplished within shared drives or enterprise content management solutions using a formal, gated process that can include one or more quality controls. The electronic document management system can further allow for document life-cycle management and enhanced document search, as well as migration to an enterprise content management system. The present electronic document management system may also provide storage, versioning, metadata, security, indexing, and retrieval capabilities. Storage can include document management functions such as where the documents are stored, for how long, migration instructions from one storage media to another, and eventual document destruction. Security may include various file permissions and passwords. Indexing may include tracking the documents with unique document identifiers and other techniques that support document retrieval, which includes locating and opening the document. Further metadata or retention schedule information can be applied to electronic documents, or electronic documents can be further classified into one or more of categories, filetypes, folders, document types for the purposes of supporting document life-cycle management, enhanced document search, or ease of access in an enterprise content management. Once complete, the new target content repository with updated metadata assigned to each document is available for simplified access, search and document retrieval.

The present system can also integrate with various other file management and metadata assignment systems to perform a document migration from one or more legacy content repositories to a target content repository. Each legacy content repository can be one a wide variety of content repositories including but not limited to file servers, Sharepoint™, cloud services, Opentext™ content server, M-files, Enterprise vault, comma separated value (CSV) files for electronic content management, electronic content management services, documents servers, or any other network database. The electronic document management utility liaises with the legacy content repository or repositories to migrate, classify and manage the electronic documents.

### Document Capture and Document Data Capture

The capture utility enables capture of available metadata elements for information objects or documents in the source shared drive or other legacy content repository. An existing folder structure can be retained and displayed, or generic or system generated, and metadata elements are captured and stored in a project database. To perform a document capture from a remote location such as at a client site, the client software is accessed and preferably downloaded and installed. Access to the client portal is preferably security protected with a password or other login credentials to establish a secure connection and authenticate use of the account.

To perform a new capture, the location of the source data is identified as a legacy content repository and the information required to access it, if any, is provided. If the legacy content repository is on a shared drive, the start location is identified by navigation. If the legacy content repository is not on a shared drive, a connection to the legacy content repository is established. Designating an electronic storage location for at least one legacy content repository can be done by a central computing device automatically creating a set of computer-readable instructions based on information in the transformation project configuration stored in the central computing device. The set of instructions can be transferred directly or via a telecommunications network to one or more computing devices with access to the documents specified in the project configuration in order to access the legacy content repository. The computing device that receives the instruction set for executing downloaded instructions obtains a file path, operating system-generated document metadata, as well as other document content. Other metadata and characteristics of each document can also be collected depending on the project requirements or document types. The computing device that receives the instruction set for migration can then compute each document's checksum from its file contents and upload the collected electronic document information to the central computing device via the telecommunications network, following initiation by a user or by one or more of the computing devices. The electronic document management system can also be set up as a new transformation project and identified by project, customer or user by creating a new project and selecting a project identifier and creating or selecting a project customer identifier.

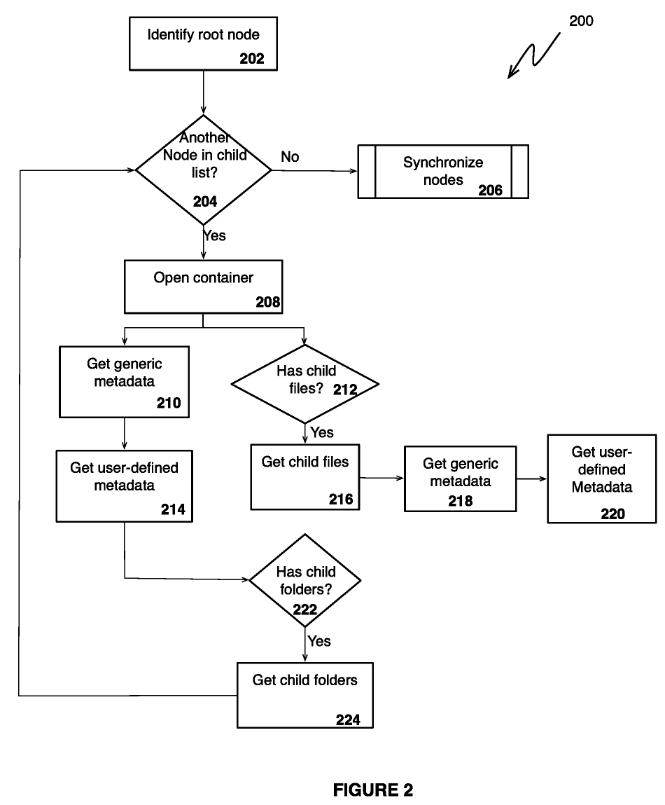

An example document capture process and document metadata capture process is shown in FIG. 2. The capturing process 200 shown in FIG. 2 for a set of electronic documents involves configuring an electronic document transformation project and identifying an electronic storage location of one or more legacy content repositories comprising the electronic documents such that the electronic documents can be captured. Once the legacy content repository is identified, the root node is identified 202. If no other node exists in the child list, the nodes are synchronized 206. If another node exists in the child list 204 then the process opens a container 208 and gets generic metadata 210 and user-defined metadata 214. If there are further child files 212, the process gets the child files 216, gets the generic metadata 218, and gets the user-defined metadata 220. If there are child folders 222, the process gets the child folders 224. The capture utility thus programmatically opens all the child folders, document libraries and other document tree repositories under a parent to capture data and metadata of descendant files. Delta captures of data added to the file share or other repository can also be taken. This process is iterated until all nodes are synchronized and all documents and associated metadata is captured.

Documents can be optionally further processed by optical character recognition (OCR) during capture. Electronic documents having sufficient business value can also be identified to receive additional processing by identifying such electronic documents on the basis of each electronic document's file size, or file path, or dates of creation or modification, or content. Identification can be done automatically by a processor on a central computing device running software to perform the analysis. In some cases, the original source structure contains valuable metadata that can be used to facilitate the document clustering and indexing process. Given that the source structure can be large, users can later filter the working classification structure generated based on captured metadata. Metadata values can then be assigned to the original source structure forcing all the files contained within to inherit that value. It is also possible that documents are already attributed with metadata which is still of value, so the existing or legacy metadata matrix can be used as a scaffold to convert legacy metadata values into the new classification structure. Cascading error correction can also be supported, such as the auto-correction of same error types across all instances of that error type. For example, all instances of a date error i/30/93 can be corrected to 1/30/93 by correcting one example of that error. The system can also support the application of business rules in a database to transform and normalize results in accordance with client requirements.

If the document organization process is carried out over a prolonged period of time, newer documents added to the legacy content repository since the instance of the first capture can synchronized with the original capture to maintain the original tree and retain document processing progress. In another embodiment, filters can be applied to capture subsets of the source documents. Various filters can include but are not limited to: date created; date range created; date modified; date range modified; date last accessed; date range last accessed; document size; numerical range of document size; or document extension (i.e. filetype). The document size or numerical range of document size can be further selected from document size range modifiers, such as b (bytes, or less than 1000 bytes), Kb (1000−1×10⁶ bytes), Mb (1×10⁶−1×10⁹ bytes), or Gb (1×10⁹−1×10¹² bytes). File types can include but are not limited to .doc, .pdf, .exe, etc. Once the classification filters have been applied the configuration can be saved and the document capture can be performed. In another embodiment, documents can be identified based on priority and captured selectively; in another embodiment, documents can be identified as being omitted from the document capture. Once the document capture is complete the captured content will be available for further processing.

### Document Classification

To classify a source object into the target tree or classification structure, documents are organized from the content source to the target structure in the working classification structure. Individual documents or folders containing multiple documents, folders and sub-folders may also be classified as a set for migration, reassignment, or both. Classifiers reorganize the legacy content into the new working classification structure. As classification proceeds and new or child folders are required, a user can select an option to create, delete or rename a new folder or value, as required.

Document classification in accordance with the present system and method comprises the steps of document clustering and indexing, document quality assurance (QA), document mapping and metadata attribution.

To classify a set of documents, document classification structure is created having document types. The set of documents will be classified into this document classification structure. A subset of those documents or training set of documents is compiled from within a larger set of documents to be classified. The training set is preferably 5% to 25% of the set of documents to be classified, and is preferably about 15%, understanding that the larger the training set, the more accurate the document classification will be. The training set is then classified based on the classification structure and classification criteria are identified from the textual content of documents in the training set and assigned to folders in the classification structure. Each document in the document training set is assigned to the classification structure and words or textual content from each classified document is extracted to assign classification criteria to each document type. As such, a classification structure is created having document types. Once properly classified, the training set becomes a collection of correctly classified documents and provides a set of criteria for classifying those documents.

The classification criteria for classifying documents can then be determined using an auto-classification algorithm that works on the natural words found within a document, file and/or metadata associated with the file. The classification taxonomy is created based on the classification structure and the classification criteria associated with each document type in the classification structure. The criteria for the training set can then be used to auto-classify documents from a larger subset of documents. The training set can either be a subset of the documents to be classified, or can be entirely independent and from a different source from the documents to be classified.

The classification of documents based on of the training set can then be accomplished by applying the classification taxonomy to the set of documents to be classified. This can be done as an unsupervised auto-classification or a semi-supervised auto-classification. When the training data used to classify the documents is compiled, the present system retains the training data, and amalgamates and curates the data and classification taxonomy in order to provide a large and dynamic training set, thus improving the accuracy of the classification system with each auto-classification effort. In enabling dynamic evolution or learning, the present method and system can provide classification result with improved accuracy over time.

The training sets and resulting classification taxonomy including classification structure and classification criteria can be industry specific or specific to business function. In one example in an insurance company, claim handling between insurance companies is generally standard. Accordingly, a classification of claims in an insurance company generally includes similar criteria or textual content, such as, for example, medical, health, industrial, value of claim, domestic, personal, dental, surgical, pharmacy, optical, physiotherapy, natural health practitioner, date, etc. Auto-classification of insurance claims documents can be done by using this textual content can provide a ranking and classification based on the importance of the term or word used in the classification. A future auto-classification of insurance claim documents can use the same classification criteria set to classify the documents. The larger the training set, the more accurate the results obtained from the auto-classification.

### Document Indexing and Clustering

Many current clustering systems require detailed knowledge of clustering algorithms and parameters in order to achieve desired results. Given the specific use cases it is possible to simplify the technology by clustering documents from the legacy content repository to assist in electronic document management. In addition, the present method and system can provide and display the results in a meaningful manner from which users can action them.

In practice, a legacy content repository is selected for clustering. Predefined clustering models are run against the legacy content repository to identify near duplicate documents, documents by filetype, or by other clustering criteria. Electronic documents can be identified on the basis of information from the user or other sources and each electronic document's content, file path, or dates of creation or modification, or this can be done automatically based on filters or algorithms. Optionally, the selection of documents is queued or flagged to receive further processing, and then transferred to a central electronic storage and computing device for such processing. Documents can further be identified as having other electronic document versions by identifying a subset of electronic documents on the basis of each electronic document's file size, or file path, or dates of creation or modification, content, template, or other characteristics. Documents with different versions can also be identified on the basis of information by a user or a computer-implemented document labelling model.

The clustering results can then be presented for review to a user. The presented results should be a random sample of all clusters and the subset set should preferably be large enough to ensure validating and approving will result in a high degree of accuracy for the total set. Each cluster lists the identified documents and the user can then systematically review each cluster in order to verify the results. Selecting a document can generate a preview for a file or document and the user can be provided an opportunity to accept or reject a file or document from a cluster. Rejecting a file or document should remove it from the cluster. Statistics can be presented to the user identifying the accuracy rate. Upon completion, if the calculated accuracy is below a high level of accuracy, such as, for example 99%, changes can be suggested to the clustering model to achieve a desirable result. A quality assurance interface such as this supports rapid review and error correction and enables efficient consideration of a large volume of documents. Additionally, a user can be able to prove the classification accuracy based on statistical sampling

In another alternative, professional clustering service functionality can be provided which has a predefined clustering model. This can be further available and customizable for different industrial or business areas based on standard document types common to specific industries or on a widely applicable classification structure. This professional clustering service can be configured to cluster across sources and ECM Types, show all documents of a certain document type and upload a target structure from a template. The user interface can also be simplified and customized for the clustering workflow. In professional clustering service functionality, a predefined clustering model is generated. Key features such as clustering all documents of a certain type together with a high degree of accuracy and minimal configuration enables users to make efficient use of the clustering results. A professional clustering functionality also provides a clustering functionality to those less inclined to learn the advanced configurations required to get the desired results. Predefined models can also be designed for a specific function or industry. In one example, when clustering technology is used to identify versions, the functionality can be automatically configured into the clustering process. Clustering can also be done across various document sources and ECM types. Clustering across numerous source locations enables simultaneous clustering and processing of a large set of documents from a variety of legacy content sources at the same time. Increasing the number of files being clustered at the same time also increases accuracy since the clustering technology will have more data to work with. Indexing and clustering of documents based on document content and/or data generates a working classification structure.

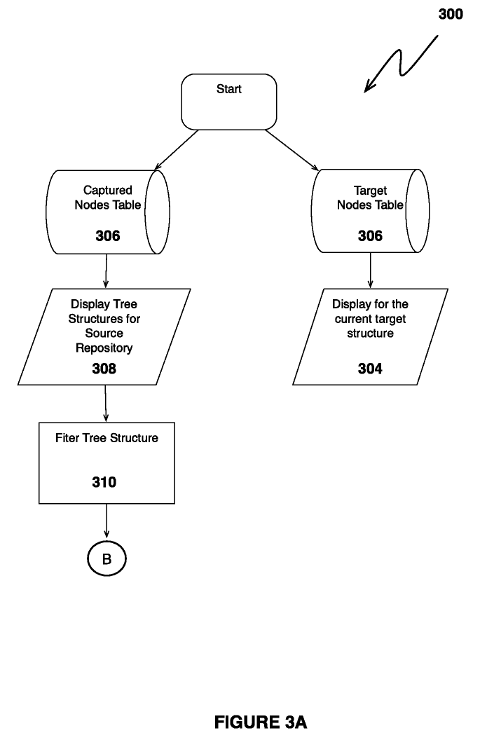

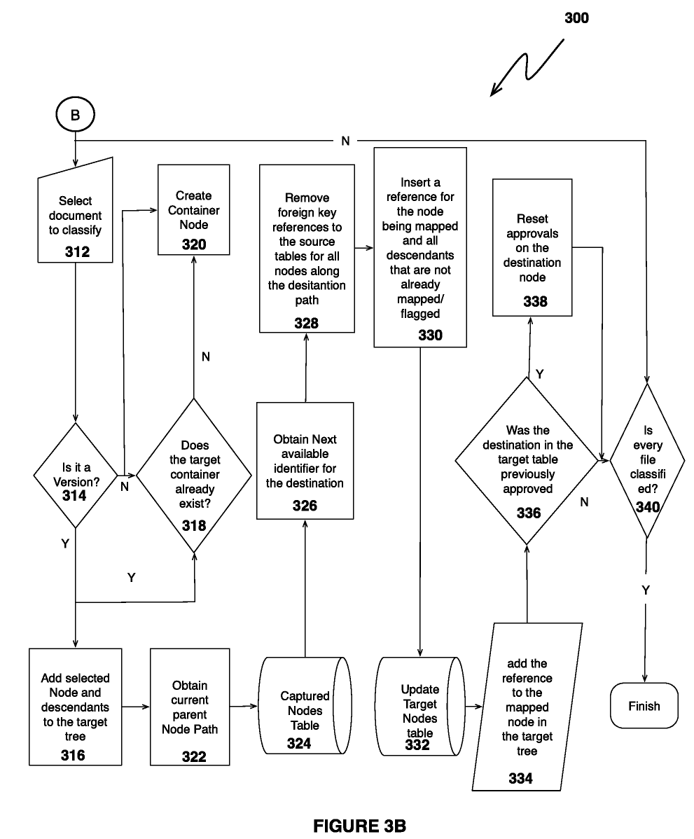

FIG. 3 is a flow chart illustrating an example document clustering process 300 to create a working classification structure according to an example embodiment. A working classification structure is composed of folders, or folder like objects, defined at multiple levels in a captured nodes table 306 and display tree structure for source repository 308. A working classification structure is presented as a target nodes table 302 and display tree for the target structure 304. Levels in the tree hierarchy represent metadata elements, and individual containers represent metadata values. Instead of building out a folder structure, a metadata model can also be defined or imported from a template. In order to identify metadata elements, the utility performs an analysis of the identified document types from the clustering process and suggests appropriate metadata elements. Once metadata elements or textual content have been defined from the documents, the metadata elements or textual content can be arranged into a hierarchy which will serve as the classification criteria, or basis for the working classification structure. Based on the proposed hierarchy, other groupings can be proposed based on metadata elements referred to as metadata groups. A filter tree structure 310 is then generated in a working classification structure. To perform a document clustering, the captured documents and associated metadata is accessed for the project. A document is selected to be classified 312 and if a version is detected 314 then the selected node and descendants are added to the target tree 316. The current parent node path is obtained 322 and added to a captured nodes table 324. The next available identifier is obtained for the destination 326 and any foreign key references to the source tables for all nodes along the destination path are removed 328. Then a reference is inserted for the node being mapped and all descendants that are not already mapped or flagged 330. Multiple versions can also be clustered together to create a family cluster. The target nodes table is then updated 332, and the reference is added to the mapped node in the target tree 334. If the destination in the target table was previously approved 336, then the approvals on the destination node are reset 338. If the selected document is not a version, then a container node is created 320 if the target container does not already exist 318. This iterative process of classifying every document is undertaken until every document is indexed and clustered 340 and placed into a working classification structure.

The working classification structure is thus constructed based on document characteristics such as document size, document type or extension, document metadata, or other aspects or features that assist with classification and/or clustering. From the capture process all document and folder names and metadata are imported and the legacy content repository can be visually recreated in a tree structure with the indexed and clustered documents in the working classification structure representing the organisation's new or target classification structure along with the representation of the legacy content.

The software programmatically removes the old source node path reference and adds the new reference for the nodes being mapped to the target tree structure, and the reference is inherited down from a parent to all descendants. Document names preferably remain unchanged at this point, however document re-naming can be performed as a later operation. Versions or drafts of documents can be classified and nested under final or official versions using the classification function. Further, documents can be renamed based on applied metadata to ease future identification. A user can also provide a desired filename format, at which point the system would proceed to rename documents so that the name conforms to the specified format.

If the document object is a version, the selected node is classified according to the classification protocol along with descendants in the target structure. This can be done by drag and drop of the version from source tree structure to target tree structure, mapping the version under the “final” record. A flag can also be applied to an object in the source to denote “Out of Scope”, “transitory”, “trash” or other designation. All source nodes are classified until complete.

Further processing can include identification of duplicate documents and removal of redundant, out-of-date or trivial (ROT) content. Identification of duplicate records can also be accomplished within the legacy document share structure. In one embodiment, the present system will identify duplicate files within the source structure and use the information to expedite the classification. Electronic document versions, duplicate electronic documents, and electronic documents with business value can also be queued to receive additional processing. During the classification process, duplicate documents can be labelled, removed, reassigned, put on a retention schedule, copied to a central electronic storage and/or computing device, or deleted.

Classification quality assurance (QA) of the correctness of the working classification structure, identification of duplicate files, identification of file versions, retention schedules and metadata, can be done by one or more users using computing devices in communication with each other by inputting approval or rejection of the working classification structure, identification of duplicate files, identification of file versions, and application of retention schedules and meta data to electronic documents, the results of which are stored in a central electronic storage. In one embodiment, the ability to QA the auto-classification results to a high degree of accuracy is accomplished by: presenting the document to a user along with the identified cluster for review; rendering the document in a brief period of time (such as, for example, less than 10 seconds, less than five seconds, or no more than 2 seconds) for quick review; allow the user to compare the document against others in the cluster; allowing the user to “reject” the suggested cluster; and summarizing accuracy statistics for the user.

In one embodiment, dynamic text shot analysis provides QA of the document classification. A user confirms the document classification by text shot analysis by viewing document text to compare to the clustering result and either confirms the classification as correct by going to the next document or by making a classification correction. Corrections can be made, for example, by assigning the document to another doc type category or classification. Database updates will occur and a check performed to ensure that all corrective actions were in fact updated. Some of the text shots may be indecipherable due to poor text quality from OCR, however those documents can be filtered using a minimum word filter (excluding stop words) and tagging failing documents for linear review. In that case, the user may need to view the native file in order to determine what document type category is relevant to assist with the document classification. In addition to employing a minimum word filter to isolate documents with poor OCR, a Minimum Word Filter/Word Count filter can be used to examine the first number of words in a document as required to perform the classification. This is applicable, for example, with compound documents such as large page count documents (typically PDF) or collections of multiple document types pertaining to a project, equipment envelope, or other factor. For example, the first 1000 words in one of these large documents can serve as a proxy for the type of compound document being processed.

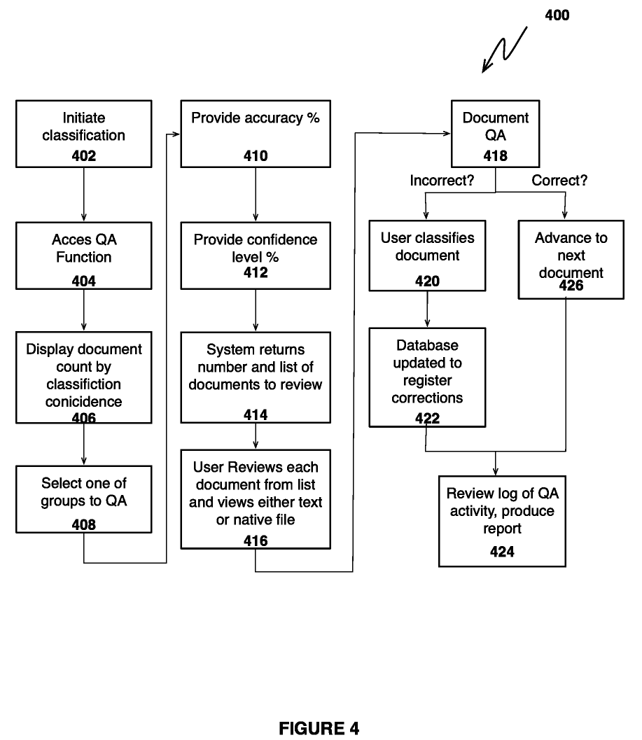

One process of classification quality assurance 400 can use a clustering method to analyse each document set by classification confidence as shown in FIG. 4. Once classification 402 is initiated, the QA function is accessed 404 and the groups of documents are displayed by classification confidence 406 as a confidence ranking. In one example, the utility can provide an equivalent to a green/yellow/red confidence level for results at the field level, and allow each category to be reviewed independently and by field. One of the document groups is then selected for QA 408 and the utility provides a classification accuracy 410 and confidence level 412. The system then returns a number and list of documents for review 414. A user reviews each document or a selection of documents from the list by viewing either text or the native file 416. Document QA 418 is then evaluated. If the correct classification is determined to have been applied, the user advances to the next document 426. If the classification is incorrect, the user manually applies a document classification 420 and the database is updated to register the correction 422. Once the classification of the selected document group is complete, a review log is provided of QA activity and a report produced 424.

Performing a quality assurance comparison of the working classification structure can also be done by a central computing device automatically creating a set of computer-readable instructions based on information in the electronic document set transformation project configuration stored in the central computing device, and downloading the set of instructions to one or more computing devices with access to the file locations specified in the project configuration. The computing devices receiving the instruction set and executing those downloaded instructions then perform the comparisons, and transfer the results to a central electronic storage and computing device. The quality assurance comparison can be done locally, or over a telecommunications network of operably linked computing devices. The system can use the confidence level as a means of segregating which documents merit what level of QA effort. For example, if a high confidence level yielded 99% accuracy, then those documents need no additional QA. Documents with a score below 99% could be further stratified into medium and low confidence buckets. Documents can be flagged as either normal or short, where short tagged documents have low amounts of quality extracted text and must be QA'd by viewing the native files. A random sample generator with user adjustable sample rates based on the assumption of a normal distribution of errors and an ability to set the confidence level can also be used in the quality assurance of the classification process. The system can track the elapsed time spent by a user performing QA during a segment of review and aggregate QA metrics across multiple QA review sessions. Results are presented to the user with a summary of overall accuracy for a collection, number of review sessions, documents reviewed, errors found and corrected. Users should be able to exit a review session without completing all documents review and be able to return later and pick up where they left off. This functionality can be supported with separate permissions.

### Regular Expression Data Extraction

Regular expressions are utilized for document search or extraction to identify a word or a phrase having the word within text data, metadata, or one or more strings of text. Formulas for extracting metadata and regular expressions from text recognized documents can be provided within the electronic document management system to streamline classification and search. The use of regular expressions in the system also allows for verification of the classification results and promotes a high level of accuracy.

In a process for extracting data using regular expressions, a set of regular expressions is created and designed to extract data from content documents. In one example, a simplified regular expression form can be provided for input from a user. One or more content repository is selected to perform data extraction on and a scan of all documents is performed to extract documents having the regular expression or variants thereon. The defined regular expression is run against the textual content of the documents, and documents and matches are then presented to the user for review. The documents presented can be from a random selection of all files from the set of electronic documents to be classified and can be further divided into a training subset and a testing subset. The testing subset set should be large enough to ensure validating and approving such that the final classification based on regular expressions will result in a high level accuracy for the total set.

A systematic review of each match provides an opportunity to verify the results. Reviewing can be enabled by selecting a document to generate a preview, and providing the location of the matching string to confirm appropriate classification. The user can reject a match and be given an opportunity to re-classify the document or provide additional metadata to construct and optimize the working classification structure. Statistics can also be presented identifying the accuracy rate of the classification. Quality Assurance of regular expression classification search results to a high degree of accuracy can entail: allowing the user to create regular expressions in order to extract data from within their documents; extracting data from documents using defined regular expressions; presenting the document and highlight the located matches for the user; rendering the document in a brief period of time (such as, for example, less than 10 seconds, less than five seconds, or no more than 2 seconds) for quick review; allowing the user to “reject” the suggested match; and summarizing the accuracy statistics for the user.

### Deep Data Extraction

Similar to metadata extraction using regular expressions, deep data extraction (DDE) provides a different approach to extracting metadata. In a deep data extraction, templates are uploaded to identify similar or derivative work or documents, with anchor points defined on the template used to extract data. In DDE, certain record types have content in the form of data elements that are important enough to extract from the content and perform QA to high levels of accuracy. These record types are commonly forms and versions of forms and can thus be planned for ahead of time. The output of the auto-classification process can be tagged for DDE processing. For example, the batch of documents classified as doc type “Mill Test Reports” (See Table 1) can have a tag applied during project setup where if that doc type is found, the documents will be sent to a queue for DDE. Advance tuning of a sample record requiring DDE can be done based on either their being a standard industry form or a standard form used by a client over a variety of fields. DDE also enables the ability to extract the same set of fields from a given form, even if the versions have a slightly different layout and have been correctly classified as the same record type. Further, a floating field position or a field location which “floats” in position but has identifiable anchor points or features can identify the field as the target field. Anchor points can also be used to extract the textual content from the set of electronic documents. Validation tables can to match field values against known tables and fuzzy analysis supports the fuzzy interpretation of a value where poor text is present in the document content, with fine tuning to increase or decrease the fuzziness interpretation against a validation table of possible results.

A legacy content repository is selected to run the deep data extraction against and the DDE is run against the electronic documents contained in the legacy content repository. Files or documents are matched against the template and the anchors are used to extract values from each document. A subset of processed files or documents are then presented to a user and their values are identified. The subset of documents should be a random sample of all documents processed from the legacy content repository and the subset set should preferably be large enough to ensure that validating and approving will result in 99% accuracy for the total set. A user can then optionally systematically review each result in order to verify the matches, whereby selecting a document should generate a preview, and provide the location of the matching string(s). The user can then either approve or reject a match. Statistics can be presented to the user identifying the accuracy rate.

Quality Assurance for Deep Data Extraction to provide results at high accuracy can entail: allowing the user to use template documents in order to find derivative documents; allowing the user to define anchor points within the template for data extraction; using the anchor point definitions to extract metadata and present it to the user for validation; presenting the document and highlight the located matches for the user; rendering the document in a brief period of time (such as, for example, less than 10 seconds, less than five seconds, or no more than 2 seconds) for quick review; allowing the user to “reject” the suggested match and/or metadata; and summarizing the accuracy statistics for the user.

In industrial sectors such as Oil and Gas, Utilities, Mining and Construction, advanced classification and metadata attribution of documentation is required at a very high rate of accuracy. In particular, accurate classification of documents enables rapid retrieval of, for example, engineering specifications, performance analysis, procurement, maintenance records, human resources and financial reporting. In a set of engineering documents, an example summary of the types of critical records or documents which would benefit from DDE is shown in Table 1:

TABLE 1
Clustering of Engineering Documents

| Critical Record | | |
|---|---|---|
| Category | Document Type | Examples of Data Being Extracted |
| Engineering/Materials | Mill Test Report | Grade, Heat Rating, Wall Thickness, |
| | | Vendor, Date, Project Number, PO |
| | | Number |
| Engineering/Materials | U1 Equipment Data | Asset Number, Date, Asset Type, Grade, |
| | Form | Heat Rating, Vendor, Wall Thickness, |
| | | ASME Code |
| Engineering/Inspection | Field Inspection Report | Date, Location, Asset ID, Inspector, |
| | | Vendor, Instrument Readings |
| Engineering/Repair | Field Repair Report | Date, Location, Asset ID, Repair Type, |
| | | Vendor |
| Engineering/Drawings | P&ID | Drawing Number, Date, Revision |
| | | Number, Asset ID(s), Location, Vendor |

### Personally Identifiable Information

A concern for all companies is the management of personally identifiable information (PII). Personally identifiable information (PII) is any data that could potentially identify a specific individual or organization, contact or locate a single person, or identify an individual in context. Any information that can be used to distinguish one person or entity from another or to de-anonymize anonymous data can be considered as PII. Examples of PII include but are not limited to name, home address, email address, national identification number, passport number, IP address, Social Insurance Number, bank account number, vehicle registration plate number, driver's license number, face image, fingerprint, handwriting sample, credit card number, digital identity, date of birth, birthplace, genetic information, telephone number, electronic login name, screen name, nickname, and online handle. Certain types of records contain PII and many examples of those records are the same across the business environment. For example, a new employee benefits application is chock full of PII in almost every case and this record type can be labeled as such and then redacted based on the presence of specific PII data elements. Regular expressions searching leverages known industry definitions of PII expressions and where no text corruption is present and can return 100% of the true positive results based on matching the expressions to the text.

Federal and state laws and regulations seek to protect this information on behalf of consumers. Certain standard types of records contain this information, as well as ad hoc documents, and companies often struggle with locating these records and redacting the PII in order to meet the legal and regulatory requirements. There are currently systems on the market designed to identify documents containing PII. Most of these systems are centralized, which limits their processing capabilities and several provide no means to action the scan results. The present electronic document management system allows scanning of all data in electronic documents in the legacy content repository and provides a centralized means to review and action those results.

Personally Identifiable Information (PII) can be identified and presented for special processing. Quality Assurance of classifying PII to a high degree of accuracy can be accomplished by allowing the user to create regular expressions in order to identify documents that contain PII. In one example a text search can be selected to express search terms more clearly, more concisely, or in an alternative style to simplify the process of creating regular expressions. To protect the PII, documents containing PII should never leave the client network. Once the regular expression has been created, the documents can be presented to a user, with search terms highlighting the located matches of the regular expression or part thereof in the document. Documents should be rendered in a brief enough period of time (such as, for example, less than 10 seconds, less than five seconds, or no more than 2 seconds) for quick review. Users can be allowed to “reject” the suggested match and accuracy statistics can be summarized for the user.

Features of PII location and redaction can include a highlight and redact, wherein if there is a match between the programmed regular expression and the content, a highlight is applied to the content and/or the expression(s) is systematically redacted. Error correction in PII documents can also be used to correct false positives and false negatives based on manual review of results. A tag can be retained in the database indicating the presence of each or multiple types of PII. Certain combinations of PII elements are more toxic than others, so a higher degree of granularity can provide additional protection. A dashboard can summarize the statistics of found PII across a selected document population.

To identify and isolate PII, a PII expression can be created as textual content and used to scan a set of electronic documents. In practice, the legacy content repository is selected and documents contained therein comprising PII are identified by performing a scan of every document in the legacy content repository. The PII can then be obscured, encoded or redacted to ensure it does not leave the originating network. A random sample or subset of processed documents can then be presented to a user for review, and the user can view each result or a selection of results in order to verify the matches. Selecting a document should generate a preview, and provide the location of the matching string(s), and the user can either approve or reject a match. The subset set should preferably be large enough to ensure that validating and approving will result in 99% accuracy for the total set. Statistics can be presented to the user identifying the accuracy rate.

### Document Mapping

To classify the content into a customizable target structure while maintaining the original location and metadata up to the migration, a user is enabled to review and confirm the document classification and mapping. In one embodiment, to confirm the mapped content users select captured files or folders and place them into the classification structure, such as via drag and drop. In another embodiment the preliminary mapping is automatic and a user confirms or corrects the auto-mapping. The mapping process assigns metadata values derived from the classification structure to the files allowing a user to browse them in the new classification structure. Some of the metadata elements the user identified earlier may not be part of the classification structure, in this case the values need to be assigned by the user. In addition to manually assigning metadata values, extraction of those values can be obtained from documents based on regular expressions and templates. Users may also view documents classified by document type to facilitate creation of an updated classification structure. Viewing similar documents can provide users an option to group several files into one document, assuming their target enterprise content management system (ECM) supports versioning. Viewing identical files can enable a user to make a quick decision to dispose of redundant content prior to migration. The process of organizing content and document classification confirmation is highly iterative and interactive.

Mapping can be carried out through several system or programmatic methods. Source data can be mapped using auto-classification, where content is clustered into a function or activity based on a set of pre-determined criteria. Machine-assisted clustering combines the use of auto-classification driving to achieve the best possible coverage in alignment with a desired confidence in the results, followed with a manual review process to correct and improve the results of the system mapping. In manual classification documents are manually mapped by drawing on context of data. During the mapping phase, content owners can be engaged to verify mapping and classification, and questions about the legacy content can be posed to the content owners or users by the classifiers conducting the mapping via a client portal. The client project portal can also provide all stakeholders with a single point of reference for all project communications including the questions posed by the classifiers. Content owners can be notified that a question has been posed and login into the secure portal to provide the classifiers with the required information. This process is conducted iteratively until all legacy content has been processed. A document classification and mapping can therefore be constructed prior to migration, enabling multiple users to participate in and agree upon a structure prior to migration. In document mapping, new folders are created and named in the target tree structure as required and the target tree structure can be displayed in a graphical user interface, all prior to document migration. Objects to be classified are selected from the legacy content repository. When a location for one document in a family cluster is determined, the family cluster can be migrated en masse into the classification structure with a shared classification.

Once documents have been classified and the working classification structure is confirmed, the application of updated metadata elements, retention schedules, classifying electronic documents into categories or folders or document types, and the managing of disposition processing can be applied to documents either individually or in groups. Electronic documents with their associated information, features or characteristics can also be used to develop a computer-implemented document labelling model with a new classification structure in a target content repository.

### Metadata Attribution

Metadata obtained from the legacy content source and information resident in the system such as created by, date created, date modified, is imported and the legacy content repository is visually recreated in a target content tree structure. Along with the representation of the legacy content repository is a legacy tree structure representing the organization's previous or starting classification structure. Metadata is attributed to content classified into the target structure using the client portal. New elements to enhance search functions, such as in ECMs, are attributed to folders, documents and files.

A metadata attribution adds metadata to an electronic document using a computing device to assign metadata sets already specified for the project to folders and the electronic documents contained therein, or to individual electronic documents or subsets thereof, optionally via the document labelling model. The system will retrieve and display assigned metadata groups assigned to the document object, such as content type or category. The system will then retrieve and display the list of elements based on the metadata groups that are assigned to the electronic document. The metadata values can be displayed and visually identified, including inherited values, required elements, and default values and a list of metadata values can be presented to a user corresponding to each element. If any values are missing from any element the metadata element can be selected to assign additional or modify existing values. Selection can be made from a free text field, drop down list or calendar for dates and a new metadata value can be entered. When all metadata has been assigned the metadata attribution is complete for that set of documents. Once each document in the set of electronic documents has been assigned a metadata attribution, the set of electronic documents or filepath thereto are stored in a target content repository. The project configuration information can then be transferred to the target content repository.

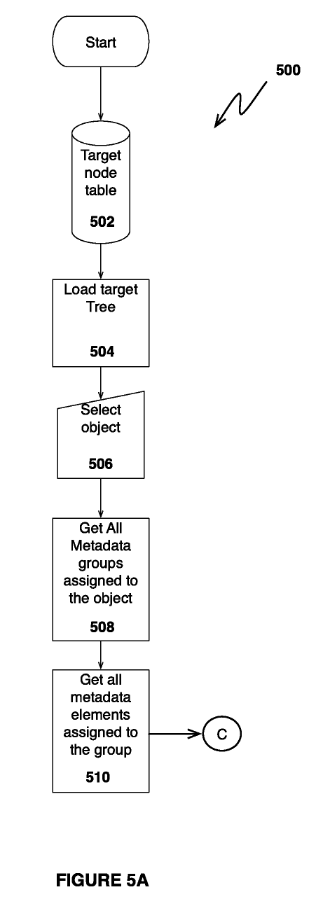

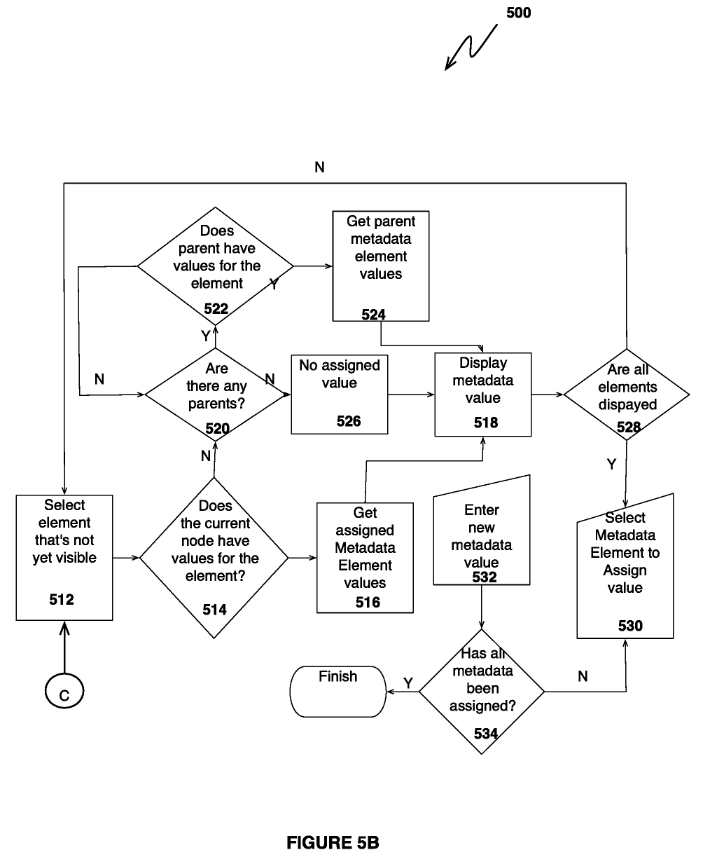

FIG. 5 is a flow chart illustrating a metadata attribution process 500 according to an example embodiment. A target node table is identified 502 and the target tree is loaded 504. An object is selected 506, all metadata groups assigned to the object are obtained 508, and all metadata elements assigned to the groups are obtained 510. A metadata group is a container of elements such as the content type of category. The system first checks if any metadata groups are assigned to a node and retrieves and displays those groups. An element is then selected that is not yet visible 512. If the current node has values for the selected element 514 then the assigned metadata element values are obtained 516. If no groups are assigned at the node level, then the system checks each parent level until one with assigned metadata is found. A search for parents 520 is undertaken to determine if any parent has values for the element 522 and those metadata groups are then inherited down to the descendants in the target content tree. If a parent does have values for the element, the parent metadata element values are obtained 524. Otherwise, no value is assigned 526, and any metadata value obtained for the element is displayed 518. Next the system retrieves the elements based on the metadata group, and displays the elements for each node or object. Once all elements are displayed 528, a metadata element is selected to assign a value 530 and the metadata is entered 532. The values of each element of the selected object may be added to or modified by inputting text in a free text field, selecting from pre-defined values in a drop-down list, or selecting a date using a calendar. The process finishes when all metadata has been assigned 534.

Retention schedule information can be applied to the electronic documents, including a retention period or time and/or disposition methods. A retention schedule can be assigned using rules specified for the project, to individual folders and the electronic documents contained therein, or to individual electronic documents. A document labelling model directing a computing device to assign retention schedule rules can set rules already specified for the project to folders and the electronic documents contained therein, or to individual electronic documents. Retention schedule information can also be assigned to individual documents, a subset of selected documents, folders, families of documents such as versions or duplicates, or to an entire project. A labelling model executed by a computing device running software can also be directed to assign additional retention schedule information to retention schedules. Any assigned retention schedule or retention information is stored as document-associated metadata.

### Document Migration

Transferring or migration of electronic documents to one or more electronic storage locations specified in the project configuration can be done by a central computing device automatically by a set of computer-readable instructions based on information in the electronic document set transformation project configuration stored in the central computing device. The system downloads the set of computer-readable instructions to one or more computing devices with access to the files specified in the project configuration, and receives the instruction set from executing those downloading instructions thereby transferring the files and associated data as specified in the instruction set. When the migration is initiated, the client application begins downloading the project information using an application such as Windows Communication Foundation (WCF) web services that interacts with the project database. The downloaded information can be stored in a temporary file. The system will first gather all the information required for migration about the target structure, for example what containers to create, the permissions that need to be set, and any metadata to be applied directly to those containers. Then the system gathers the information required to migrate the documents, including their target location and assigned metadata, which is stored in an encrypted file to reduce communication errors once the migration begins. The system first creates the migration target folder structure, assigns folder level metadata and folder level permissions in one step, then migrates the document data from the source to the target and assigns document metadata in a second step. Finally, the system sets the document “created date” and “modified date” to match the dates in the source data. The dates are retrieved directly from the source object being migrated, at the time of migration. These steps can be automatically performed.

In a migration the utility can automatically delete the content that has been approved for disposition. Alternatively, the user can determine whether the files will be deleted or moved to a staging area for further review. If the content is not to be disposed, the content can be automatically processed based on whether the target repository is a shared drive or an Enterprise Content Management (ECM) system. In particular, if the target repository is a shared drive, the content of the legacy structure is automatically re-organized into the new structure. If the target repository is an ECM system, the taxonomy is built out, the content uploaded from another ECM or shared drive, and any metadata defined is assigned in the new structure.

The system will download information about the project using, for example, WCF web services that interact with the project database. Information can be stored in a temporary file. The information gathered about the project includes the target structure, containers to create, permissions to assign and metadata assigned to the containers. The system then gathers information required to migrate the documents such as location in the target folder structure and assigned metadata values. The capture status will be updated to reflect the current stage once the software begins processing the request. The number of documents migrated can periodically update to show migration progress.

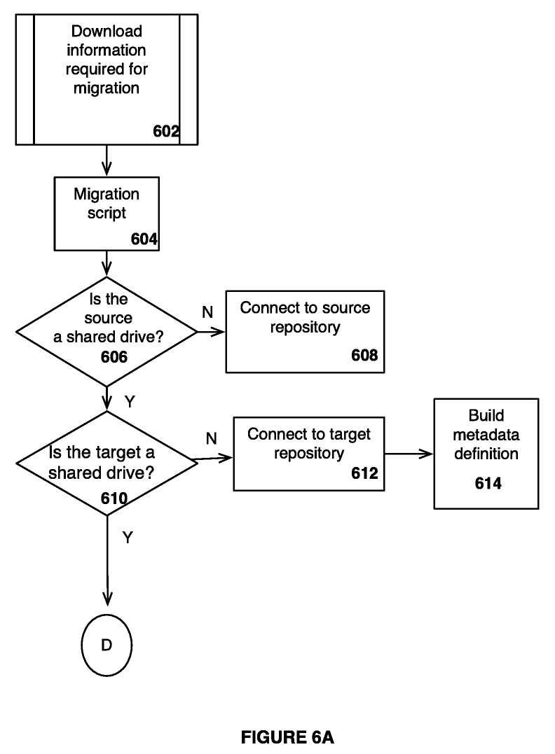

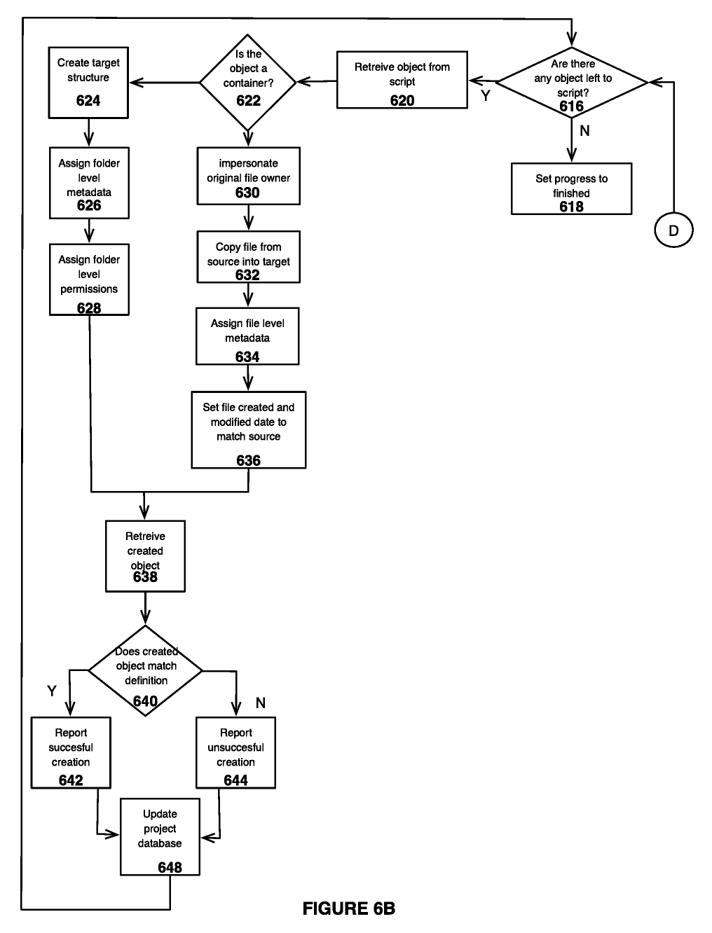

FIG. 6 is a flow chart illustrating a migration process 600 according to an example embodiment. In this embodiment, to perform a migration, a new migration target is added, such as a legacy content repository. The destination location for the source data is determined and any information required to access it is entered to gain access by downloading information required for migration 602. The migration script is run 604 and a determination is made as to whether the source is a shared drive or not 606. A test to check the connectivity to the destination server is preferably done and the destination target is committed and saved. If the source is not a shared drive, the migration needs to be connected to the source repository 608. A pre-migration check can be run to ensure all content in the legacy repository is compatible with the destination system. If the target is note a shared drive 610 then a connection to the target repository is made 612 and the system builds a metadata definition 614. Once any target repositories are shared and the pre-migration check has successfully completed, the migration script 616 can be queued to begin. Objects are retrieved from script 620 and a determination is made whether the object is a container 622. If so, a target structure is created 624, a folder level metadata is assigned 626 and folder level permissions are assigned 628. If the object is not a container, the original file owner is impersonated 630, the file is copied from the source into target 632, file level metadata is assigned 634 and the set file is created and date modified to match the source 636. Once the created object is retrieved 638 a determination is made whether the created object matches the definition 640. If so, the successful creation is reported 642; if not, an unsuccessful created is reported 644. The project database is then updated 646 and the script run again until no more objects remain in the script 618.

As each document migrates, the contents of the destination will be checked to ensure target quality. The final operation of a migration is a quality assurance (QA) check whereby the system programmatically verifies that each object migrated into the new target repository exactly matches the object in the project database. The check verifies for correct file location, generic and user assigned metadata. If the data matches then the migration is deemed successful. The result of the QA check is reported for user review. A QA report can be provided on the client portal after transferring the set of electronic documents by performing a quality assurance comparison between the set of electronic documents that were actually transferred and their locations and the new classification structure of the electronic documents.

### File Storage

The migration utility can also allow the files to remain in the source repository and create a stub inside of Content Server pointing to the original. A content server storage provider can also be used to define where file content is stored in the target content repository. Alternatively, the files may be moved in part or in their entirely to a new file storage location.

In one example, a content storage provider can use a set of Representational state transfer (REST) Web Services to redirect the content to a configured storage platform. A user can then manage and present content through a content server while storing the data in a more desirable storage solution. In one example, a storage provider web services configures the storage location, such as specifying the Enterprise Vault server's DNS name. The storage provider module is deployed within the content server and specifies the storage rules for content, for example stored files placed inside of folder A into the Enterprise Vault Archive B. Users create or place documents inside the configured storage location within the content server. The content server storage provider accesses the REST Web Services and transfers the file content along with available metadata assigned to them. The Web Services initialize a connection to the configured repository and transfer the content to it for storage, returning the new unique identifier for the item back to the storage provider which uses the information to link the two entities. When a user requests the content stored using this provider, the data is fetched out of the repository using the unique identifier stored from the previous step.

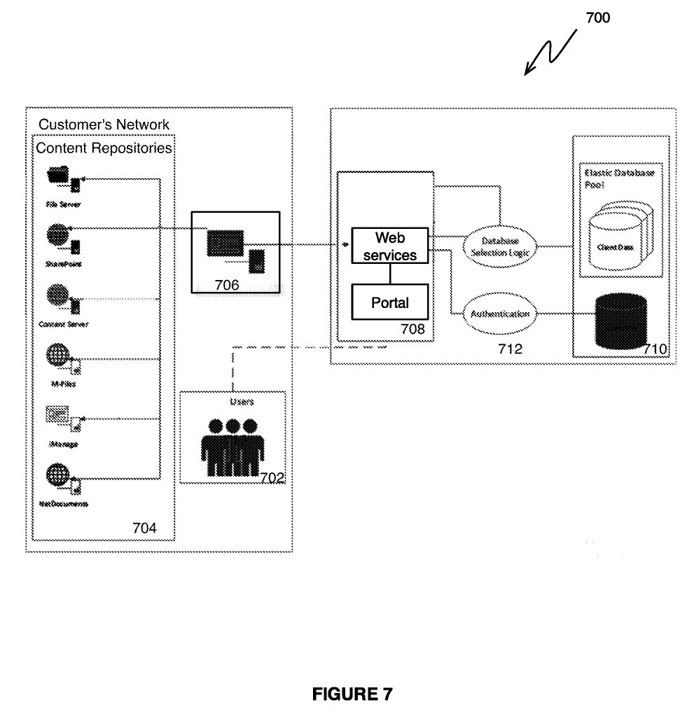

A system overview of an implementation of the present system 700 is shown in FIG. 7. A client network 702 contains a content repository 704 comprising one or more document storage systems, servers, or file management storage systems. A client utility 706 liaises with the content repository 704 through an application 706 which can be accessed by one or more users 708 and connects the users 708 to a cloud based computing platform 710.

Data archiving is employed by many organizations to unburden high use or daily use systems. In particular, electronic mail archiving systems or Content Repositories such as Enterprise Vault™ are used to unburden Microsoft Exchange systems from storing millions of objects in its database and instead stores the object in the content repository, and stores a “stub” in Exchange™ that points back to the object if it needs to be retrieved. The present system performs a similar function and operates in an Open Text™ Content Server environment. In one example, an organization would use the present system in a Content Server environment are if they are moving files from a shared drive into a Content Server, or if they want to manage content that already resides in a content server through its lifecycle using Content Server. In this example, a user will “capture” the documents or files in a shared drive or other repository and process them using the present system as normal. When they are ready to migrate the content, the files are actually moved to a Content Repository content server and a “stub” is placed in the Content Server by the present process. Subsequent access to the files by the user is managed through a Content Server Module that processes each access request and retrieves it from the Content Server for use by the user. In another scenario, the user captures the files from a Content Repository and processes them as normal. When they are ready to migrate, the files actually stay where they are and the “stub” is placed in the Content Server without any moving of content.

Two components that perform this action of connecting the Content Repository with the Content Server within the present system are:
1. A modified “Migrate” module that adds the stubs to Content Server and
2. A Content Server module that is intelligent enough to know how to process Content Repository content.
   If the system is configured to treat the Content Repository as the content archive, the Content Server module will create an Content Repository document or stub with all the requisite information to both retrieve the content from the Content Repository and manage the interaction between Content Server and the Content Repository when a user or the Content Server system needs to access the file.

Another scenario in which an organization would use the present method and system to manage and organize a content repository such as Enterprise Vault™ is if the organization does not have a Content Server but they want to classify/attribute content and migrate it from a shared drive into the content repository. In order to do this, the “Migrate” module can be adapted to migrate content into a content repository such as Enterprise Vault™ through a File System Archive product such as that offered by Veritas™.

Additional features can be provided such as an associated or embedded communications system having a computer-implemented user-to-user chat and/or computer-implemented bulletin board, both of which can be configured to receive and send information via email messages as well as through their own graphical user interfaces. Can serve as a record of a classification decision. Cloud aspect of platform-central repository where things are stored, instructions stored within that repository. An integrated or connected telecommunications network can transfer data and computer-readable instructions from one computing device to another, such as various operably connected computing devices having memory capable of storing instructions and data and one or more processors to execute instructions to perform operations.

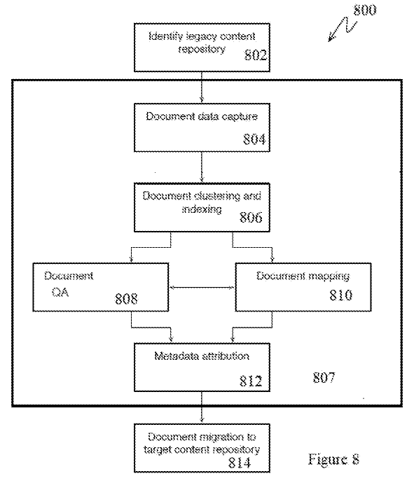

With reference to FIG. 8, another aspect of the present invention is represented where documents and information stored in memory of a legacy content repository 802 is processed via a method of data capture, document clustering and indexing performed by a client utility 809, which can be located in a network 800 or in a cloud. Document data capture step 804 includes access and capture of critical document metadata and content information that is extracted from textual content in each document stored in the repository/server. Document data obtained from the document data capture step 804 is then processed in a document clustering/classification and indexing step 806 which is performed to group documents within the set of documents into clusters based on similar criteria. This step facilitates the identification of document types to generate clusters used to group and present groups of documents with similar content to users. These data analysis steps provide updated document clusters based on the document data. Clustering of electronic documents can be used to identify documents by document type. Examples of file types of electronic documents to be managed can include but is not limited to documents that are attachments, emails, word processor documents, presentation documents, scanned documents, faxes, spreadsheets, drawings, figures, graphics, audio recordings, electronic mail (email), fax, handwritten notes, telephony recordings, portable document format (PDF), text messaging, invoice meeting minutes, memo, budgets, employee records and the like. Step 806 also includes document quality assurance, document mapping, and metadata attribution. After clustering/classification and indexing is performed, migration to a target content repository 814 can be performed according to the classification structure, where once transferred, easier and quicker access to information can be performed using the classification stored on the target content repository.

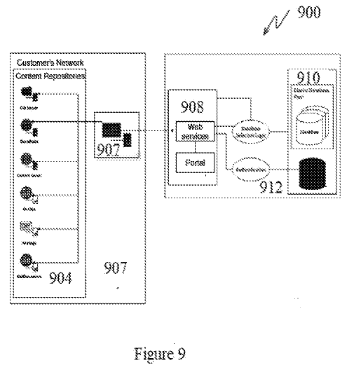

A system overview of an implementation of the method in FIG. 8 is shown in FIG. 9. A client network 907 contains at least one content repository 904 comprised of one or more document storage database, file management storage system, and/or server. A client utility 909 implements the method steps of 807 represented in FIG. 8 and liaises with one or more of the content repositories 904. In one embodiment, client utility 909 resides on a server in the client network 907. In another embodiment (not shown), those skilled in the art will identify that client utility 909 can reside in cloud 900 or on another network. In one embodiment, the client utility 909 can be accessed by a user via a portal 908 that is connected to cloud 900 based computing platform 912. In another embodiment (not shown), the client utility 909 can be accessed by a user via a portal 908 that is located within client network 907.

The system and method of FIGS. 8 and 9 is described with reference to a content repository 904 and enables identification, classification and management of information on at least one content repository 907, but is silent to identification, classification and management of other devices that may be connected in client network 907.

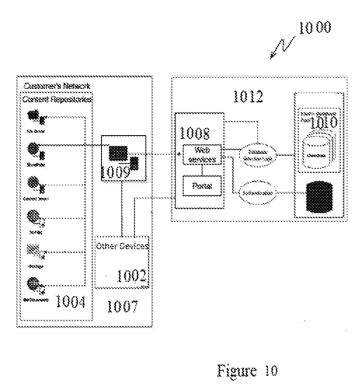

With reference to FIG. 10, in addition to the represented repositories, there is seen an information identification, classification and management system that shows a representation of all other devices 1002 connected within a network 1007. The system and implementation represented in FIG. 10 addresses the concerns of the General Data Protection Regulation (GDPR) (Regulation (EU) 2016/679) with regard to personally identifiable information (PII). Generally shown in FIG. 10 is a client utility 1009 that is configured to identify components connected to client network 1007, where 1004 represents one or more repository of information and 1002 represents all other devices in the client network. In embodiments, devices 1002 comprise but are not limited to: computers, laptops, tablets, cell phones and all other devices capable of storing information in memory and communicating within client network 1007.

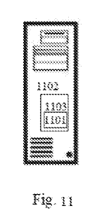

With reference to FIG. 11, there is seen a representative device 1102 having a memory 1103. In one embodiment, to facilitate identification of all information stored on device 1102, an application 1101 is installed in the memory 1103, where the application is configured to enable user's having proper authorization to use a portal to access each device in the network and to use the application on each device to identify information residing in the memory of the device. In one embodiment, the application is used to identify all personally identifiable information (PII) on each device.

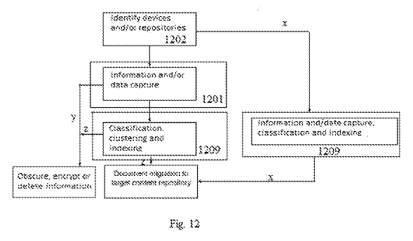

FIG. 12 represents repositories and devices as 1202, where information on 102 is identified, then captured, and then classified, clustered and indexed by a client utility 709 (see path x) and subsequently transferred to a target repository in a manner similar to that discussed with reference to FIGS. 8 and 9; or identified by an application 1201 stored in the memory of on a device 1202 and then obscured, encrypted and deleted (see path y); or identified by an application 1201 and classified by a client utility 1209 before obscuring, encrypting or deleting or migration to a target repository (see paths Z).

In one embodiment, to identify and isolate PII, a user logged in at a portal creates a textual expression that is used to scan and capture information across all the memory of each device. Typical examples of textual information that can be used to scan memory includes phrases and acronyms that typically represent PII, for example, phrases and acronyms that include but are not limited to: “SS”, “SSN, “DOB”, “sex”, “height”, “weight”, “phone”, “age”, etc. Regular expression searching leverages known industry definitions of PII expressions and where no text corruption is present can return 100% of the true positive results based on matching the expressions to the text. In one embodiment, a user logged in at a portal can obscure or encode the information on a case by case basis to ensure that the PII cannot be accessed on or off a network. In one embodiment, encoded PII can be transferred to a repository that is part of the network or to some other network. In one embodiment, a user at portal is able to delete the PII from the memory of one or more device 1202 and, thus, from the network.

In one embodiment, the present invention identifies that it may be preferred to first classify and/or analyze the information before making a determination that it be obscured or encoded, or deleted from a device 1202. To this end, with reference to FIG. 12, a classification and analysis step may be performed by client utility 1209. When used with devices 1202, client utility 1209 provides function similar to that of client utility 909 in FIG. 9, except, that it delegates identification of information on each device 1202 to application 1201. After an application 1201 on each device 1202 scans the memory of each device, the client utility 1209 can be used to index and classify all or a subset of the information retrieved from one, a subset, or all the devices. In one embodiment the information is classified according to whether it is PII. In one embodiment, the classified PII can be presented to a user at the portal for review and the user can view the results or a selection of the results in order to verify matches are in fact PII that require obscuring, encoding or deletion, which the user can perform on a device by device basis. In one embodiment, client utility 1209 can perform an analysis step to statistically determine which identified information is in fact PII. For example, if the analysis step determines that the occurrence of the textual string “SS” in fact represents the Social Security Number of persons, a user at the portal would be assured that obscuring, encrypting, or deleting the information, either from an individual, or across a class of the devices 1202, would in fact perform deletion of PII. When selecting a classified subset of PII, the subset set should preferably be large enough to ensure that validating and approving will result in 99% or better accuracy for the total set. Statistics can be presented to the user identifying the accuracy rate. In the case of a 99% accuracy determination for a particular classification of PII, a user at a portal can be assured that deletion obscuring, encoding, or deleting of PII would be appropriate. In one embodiment, in the case of a high accuracy determination for a particular PII, rather than deletion of the PII on devices by a case by case basis, a bulk erasure of PII on all devices can be initiated by a user.

Features of PII location and redaction can include highlighting and redaction, wherein if there is a match between the programmed regular expression and information on a device, a highlight is applied to the information and/or the expression(s) is systematically redacted. Error correction in PII documents can also be used to correct false positives and false negatives based on manual review of results. A tag can be retained in the database indicating the presence of each or multiple types of PII. Certain combinations of PII elements are more toxic than others, so a higher degree of granularity can provide additional protection. A dashboard can summarize the statistics of found PII across a selected population of device and/or information.

In one embodiment, client utility 1209 can be configured to be comprised of separate modules (see for example, FIG. 12), where one module is configured to identify, classify, and analyze information stored in repositories in a manner to that described with reference to FIGS. 1 and 2, and where another module is configured to classify, manage and analyze information stored in the memory of devices. Separate modules enable the present invention to be marketed for use in a network comprised of only repositories or in a network comprised only of devices.

Although the present invention has been described in the context of PII, those skilled in the art will recognize that data and information that may be identified, classified and/or analyzed according to principles and methods described above is not limited to PII, but also includes documents, data and information in the form of attachments, emails, word processor documents, presentation documents, scanned documents, faxes, spreadsheets, drawings, figures, graphics, audio recordings, electronic mail (email), fax, handwritten notes, telephony recordings, portable document format (PDF), text messaging, invoice meeting minutes, memo, budgets, employee records, and confidential information etc.

The embodiments represented by FIGS. 8-12 enable scanning of all data and information in electronic documents in a legacy content repository as well as devices connected to a network and provides a centralized means to review and action those results.

The invention being described above, it will be appreciated by those skilled in the art that the invention may comprise variations. Such variations are not to be regarded as a departure from the scope of the invention, and such modifications as would be obvious to one skilled in the art are intended to be included within the scope of the following claims.

1. An electronic document management system comprising:
one or more processors; and
a memory accessible to the one or more processors, the memory storing instructions executable by the one or more processors to:
identify a legacy content repository comprising a set of electronic documents;
capture source data for the set of electronic documents from the legacy content repository;
extract textual content from each electronic document in the set of electronic documents to identify classification criteria;
classify each electronic document in the set of electronic documents into a classification taxonomy, wherein the classification taxonomy comprises a classification structure and the classification criteria; and
attribute updated metadata for each electronic document in the set of electronic documents according to the classification structure.

2. The system of claim 1, wherein the one or more processors is configured to migrate the set of electronic documents and captured data from the legacy content repository into a target content repository using the classification structure.

3. The system of claim 2, wherein the one or more processors is further configured to store a stub that points back to each electronic document in the set of electronic documents in the classification structure.

4. The system of claim 3, wherein the processor comprises storage, versioning, metadata, security, indexing, and retrieval capabilities.

5. The system of claim 1, further comprising an associated or embedded communications system.

6. The system of claim 1, further comprising a cloud memory structure for storing the classification taxonomy.

7. The system of claim 1, wherein the one or more processors are in more than one computing device in communication over a telecommunications network.

8. A method for information identification and management in a network of devices comprising:
identifying at least some devices in the network;
accessing information on the at least some of the devices;
classifying the information to identify if the information is personally identifiable information; and
deleting the information from the devices if the information is personally identifiable information.

9. The method of claim 8, where the at least some of the devices comprises all the devices in the network.

10. The method of claim 9, where the step of deleting is performed from a single location.

11. The method of claim 10, where the single location is located outside the network.

12. The method of claim 8, where the step of deleting is performed from a single location by an authorized user.

13. A method for information identification and management in a network of devices comprising:
identifying at least some devices in the network;
accessing information on the at least some of the devices;
determining if the information falls within a certain class of information; and
deleting the information from the devices if the information falls within the class of information.

14. The method of claim 13, where the at least some of the devices comprises all the devices in the network.

15. The method of claim 14, where the step of deleting is performed from a single location.

16. The method of claim 15, where the single location is located outside the network.

17. The method of claim 13, where the step of determining includes a statistical analysis that determine if the information is classified properly.

18. The method of claim 13, where the information comprises personally identifiable information.

19. The method of claim 15, where the information is identified by comparison against textual information provided at the single location.
